(19) United States
(12) Patent Application Publication
(10) Pub. No.: US 2022/0288540 A1
(43) Pub. Date: Sep. 15, 2022

(54) FLUID-SEPARATION CARBON MEMBRANE MODULE

(71) Applicant: TORAY INDUSTRIES, INC., Tokyo (JP)

(72) Inventors: So KAKIYAMA, Otsu-shi (JP); Takaaki MIHARA, Otsu-shi (JP)

(73) Assignee: TORAY INDUSTRIES, INC., Tokyo (JP)

(21) Appl. No.: 17/635,767

(22) PCT Filed: Sep. 25, 2020
(86) PCT No.: PCT/JP2020/036234

§ 371 Date: Feb. 16, 2022

(30) Foreign Application Priority Data
Oct. 30, 2019 (JP) 2019-197077

(51) Int. Cl. B01D 71/02; B01D 63/04; D02G 1/02; D02G 3/44

(52) U.S. Cl. CPC B01D 71/021; B01D 63/043; D02G 1/0206; D02G 3/44; D10B 2505/04

(57) ABSTRACT

An object of the present invention is to provide a fluid-separation carbon membrane module that can suppress defects on a surface of a carbon membrane or breakage of the carbon membrane and suppress suction of a potting material even in a case where a carbon membrane having low ductility is used, and the main idea of the present invention is a fluid-separation carbon membrane module in which a plurality of covered carbon membranes in which at least one covering yarn is helically wound around one or two fluid-separation carbon membranes are housed in a vessel.

### TECHNICAL FIELD

The present invention relates to a fluid-separation carbon membrane module.

### BACKGROUND ART

As a separation method for selectively separating and purifying specific components from various mixed gases and mixed liquids, a membrane separation method is known. Since the membrane separation method uses a pressure difference or a concentration difference, there is an advantage in that the amount of heat energy used is small as compared with other separation and purification methods. In the membrane separation method, in particular, in applications where heat resistance or chemical resistance is required, a carbon membrane is preferably used as a separation membrane. In this case, in order to increase a membrane area per unit volume, a carbon membrane module in which a plurality of carbon membranes are housed in a vessel is used.

As a fluid-separation carbon membrane module or element, so far, there have been proposed a hollow yarn separation membrane element including: a hollow yarn bundle (1) reinforced by winding a thread-like substance around an outer circumference of a bundle composed of a plurality of hollow yarn separation membranes; a hollow yarn bundle (2) in which a large amount of the hollow yarn bundles (1) are bundled; and a tube plate provided at least at one end of the hollow yarn bundle (2) (for example, see Patent Document 1), and a fluid-separation carbon membrane module in which two or more fibrous fluid-separation carbon membranes are laminated in parallel or a plurality of fluid-separation carbon membrane elements arranged in a plurality of bundles are housed in a vessel, in which the plurality of fluid-separation carbon membrane elements are housed so that an angle formed by an arrangement direction of the fluid-separation carbon membranes and a flow direction of a fluid to be separated or a separation fluid is 80 degrees or more (for example, see Patent Document 2). In addition, as a method for producing a gas-separation membrane module, there has been proposed a method for potting or casting a bundle of hollow fibers to form a tube sheet, the method including: putting a bundle of hollow fibers into a mold; injecting a solid-filled resin into the mold; and exposing the resin to an ultrasonic field while injecting the resin (for example, see Patent Document 3).

### PRIOR ART DOCUMENTS

### Patent Documents

Patent Document 1: Japanese Patent Laid-open Publication No. 2001-300267

Patent Document 2: Japanese Patent Laid-open Publication No. 2017-131882

Patent Document 3: Japanese Patent Laid-open Publication No. 11-290661

### SUMMARY OF THE INVENTION

### Problems to be Solved by the Invention

Patent Document 1 discloses an example of using the hollow yarn bundle (1) composed of five hollow yarns, but since the hollow yarns are close to each other in such a hollow yarn membrane bundle, suction of a potting material by a capillary phenomenon is problematic. In addition, in a case where a carbon membrane which has low ductility and is easily broken is used as a hollow yarn, there is a problem in that defects or breakage is likely to occur due to contact between hard and brittle carbon membranes that are close to each other in the hollow yarn membrane bundle during production or transportation of the module. In addition, also in the techniques described in Patent Documents 2 and 3, when the number of carbon membranes to be housed is increased, the possibility of breakage increases when handling a carbon membrane which has low ductility and is easily broken. Since the carbon membrane tends to have a sharp broken surface, in a case where breakage occurs during production of the module, it is likely to cause defects or breakage of the surrounding carbon membrane. Furthermore, when the carbon membranes are close to each other, there is a problem in that suction of the potting material is likely to occur due to a capillary phenomenon. The suction of the potting material causes a decrease in effective surface area of the carbon membrane.

Therefore, an object of the present invention is to provide a fluid-separation carbon membrane module that can suppress defects on a surface of a carbon membrane or breakage of the carbon membrane and suppress suction of a potting material even in a case where a carbon membrane having low ductility is used.

### Solutions to the Problems

In order to achieve the objects, the present invention includes the following configurations. That is, the present invention is a fluid-separation carbon membrane module in which a plurality of covered carbon membranes in which at least one covering yarn is helically wound around one or two fluid-separation carbon membranes are housed in a vessel.

### Effects of the Invention

The fluid-separation carbon membrane module of the present invention can suppress suction of the potting material and defects on the surface of the carbon membrane or breakage of the carbon membrane.

### BRIEF DESCRIPTION OF THE DRAWINGS

FIG. 1 is a schematic view showing a cross section of a fluid-separation carbon membrane module including an inlet and an outlet according to one aspect of the present invention.

FIG. 2 is a schematic view showing a covered carbon membrane used in the fluid-separation carbon membrane module according to one aspect of the present invention.

FIG. 3 is a schematic view showing a covered carbon membrane used in the fluid-separation carbon membrane module according to another aspect of the present invention.

FIG. 4 is a schematic view showing a multiple covered carbon membrane used in the fluid-separation carbon membrane module according to one aspect of the present invention.

### EMBODIMENTS OF THE INVENTION

In a fluid-separation carbon membrane module (hereinafter, may be simply referred to as a “module”) of the present invention, a plurality of covered carbon membranes in which at least one covering yarn is helically covered on a core yarn formed of one or two fluid-separation carbon membranes are housed in a vessel. Here, the fluid-separation carbon membrane has a shape capable of being wound by the covering yarn, and has, for example, a thread-like shape. In addition, it is understood that “covering” by the covering yarn is a state where a part of an outer surface of the fluid-separation carbon membrane is blocked by the covering yarn and is apparently invisible. That is, in the fluid-separation carbon membrane module of the present invention, the plurality of covered carbon membranes in which at least one covering yarn is helically wound around one or two fluid-separation carbon membranes are housed in the vessel.

Hereinafter, the present invention will be described with reference to the drawings and examples. However, the present invention is not be construed as being limited to the examples.

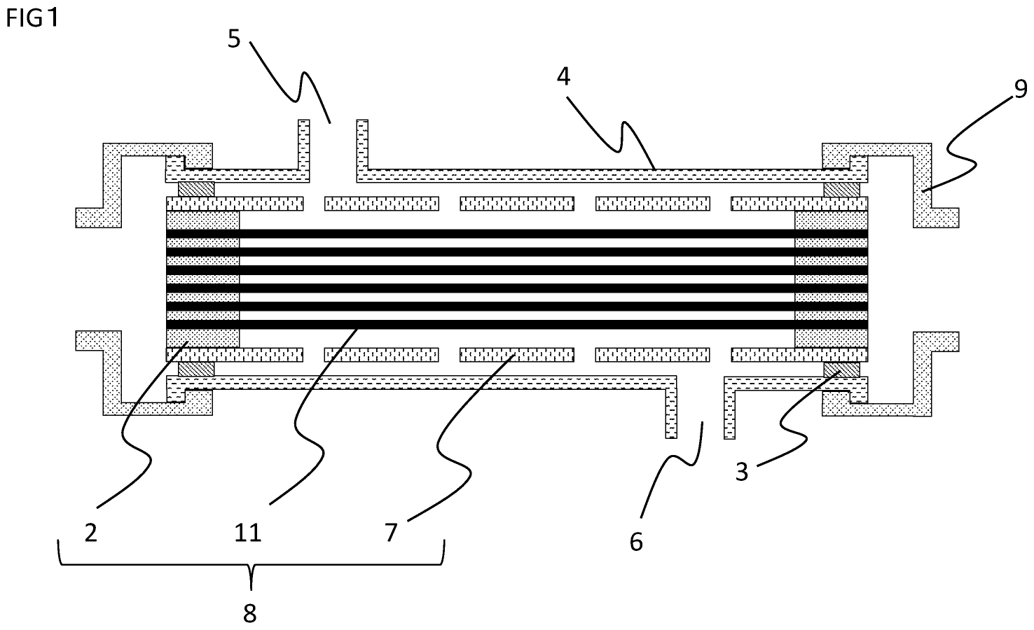

FIG. 1 shows a schematic view of a cross section of the fluid-separation carbon membrane module according to one aspect of the present invention. FIG. 1 is a schematic view of a cross section of a module including an inlet and an outlet. The module of the present invention includes a carbon membrane element 8 in a vessel 4 having an inlet 5 and an outlet 6 for a fluid to be separated. The carbon membrane element 8 includes a plurality of covered carbon membranes 11 bundled in parallel in an element casing 7, and both ends of the plurality of covered carbon membranes 11 are fixed (potted) at potting sites 2 and also fixed to the element casing 7. The covered carbon membrane 11 penetrates through the potting site 2 and is connected to an external channel (not shown) (a channel for collecting the fluid permeated into the carbon membrane) via a cap 9 attached to the outside of the vessel 4. In addition, the carbon membrane element 8 is arranged in the vessel 4 with an adapter 3 interposed therebetween.

A mixed gas or a mixed liquid to be separated by the module of the present invention is not particularly limited, and can be appropriately used in applications requiring heat resistance or chemical resistance by utilizing heat resistance or chemical resistance of the carbon membrane. Examples of the applications requiring heat resistance or chemical resistance include a system for separating and storing carbon dioxide from exhaust gas of a power plant, a blast furnace, and the like, sulfur component removal from gasified fuel gas in coal gasification combined power generation, purification of biogas or natural gas, and purification of hydrogen from organic hydrides.

In the module of the present invention, a cross-sectional shape of the vessel is preferably an elliptical shape, a circular shape, or the like, and more preferably a circular shape, from the viewpoint of improving pressure resistance of the vessel. Here, a cross section of the vessel refers to a cross section of the vessel perpendicular to a length direction of the fluid-separation carbon membrane. Examples of a material of the vessel include a metal, a resin, and a fiber-reinforced plastic (FRP), and can be appropriately selected according to an environment of an installation site or a situation where the vessel is used. In the applications requiring pressure resistance or heat resistance, a metal having both strength and molding processability is preferable, and stainless steel or the like is more preferable.

The inlet and the outlet arranged in the vessel have a function of guiding the fluid to the fluid-separation carbon membrane. In a case where the fluid-separation carbon membrane is used in a total amount filtering system, the fluid-separation carbon membrane may have one inlet and outlet, and in a case where the fluid-separation carbon membrane is used in a cross flow filtering system, it is preferable that the fluid-separation carbon membrane have two or more inlets and outlets in total. A plurality of inlets and outlets may be included in a range in which mechanical strength of the vessel is maintained. In this case, it is preferable to arrange a fabric such as a mesh or a felt between the inlet and/or the outlet and the fluid-separation carbon membrane in a range in which the passage of the fluid is not inhibited, and an effect of diffusing the fluid or protecting the fluid-separation carbon membrane is exhibited.

In the module of the present invention, the number of carbon membrane elements housed in one vessel may be one or more, and in a case of an application requiring a large carbon membrane area, it is preferable that a plurality of carbon membrane elements be housed in the vessel. The plurality of carbon membrane elements may be connected in series or in parallel.

In the carbon membrane element included in the module of the present invention, the plurality of covered carbon membranes are fixed by a potting material, and is preferably fixed to an inner surface of the vessel. Examples of a method for fixing the carbon membrane element to the inner surface of the vessel include a method for directly fixing the carbon membrane element to the inner surface of the vessel using a potting material itself, and a method for fixing the carbon membrane element to the inside of the vessel via an adapter or the like (as an example, an O-ring or the like) that can secure liquid-tightness or air-tightness. Since only the carbon membrane element can be replaced when the performance of the carbon membrane element deteriorates over time, it is preferable to fix the carbon membrane element to the inside of the vessel via an adapter or the like.

The carbon membrane element may have one or a plurality of potting locations, and from the viewpoint of sufficiently fixing the position of the covered carbon membrane and maintaining the effective surface area of the fluid-separation carbon membrane, it is preferable to fix two ends of the plurality of covered carbon membranes bundled in a substantially straight line by the potting material. In addition, both ends of the covered carbon membrane may be fixed by the potting material at one location in a state where the plurality of bundled covered carbon membranes are bent in a U shape, or only one end of the covered carbon membrane may be fixed by the potting material and the other end may be sealed by a means other than the potting material.

Examples of the potting material include a thermoplastic resin and a thermosetting resin. Further, other additives may be contained.

Examples of the thermoplastic resin include polyethylene, polyethersulfone, polystyrene, polyphenylene sulfide, polyarylate, polyester, liquid crystal polyester, polyamide, and polymethyl methacrylate. Examples of the thermosetting resin include an epoxy resin, an unsaturated polyester resin, a urethane resin, a urea resin, a phenol resin, a melamine resin, and a silicone resin. Two or more of these resins may be used. Among them, the epoxy resin and the urethane resin are preferable from the viewpoint of a balance between moldability, curing time or adhesiveness, hardness, and the like.

Examples of the additive include a filler, a surfactant, a silane coupling agent, and a rubber component. Examples of the filler include silica, talc, zeolite, calcium hydroxide, and calcium carbonate, and the filler exhibits effects such as suppression of heat generation by curing, improvement of strength, and thickening. In addition, the surfactant or the silane coupling agent has an effect of improving handleability when mixing the potting material or improving infiltration properties between the fluid-separation carbon membranes when injecting the potting material. In addition, the rubber component exhibits an effect of improving toughness of a cured potting material. The rubber component may be contained in the form of rubber particles.

In addition, as one aspect of the present invention, the carbon membrane element may have a casing (hereinafter, described as an “element casing”) different from the vessel. It is preferable that the element casing have the inlet and/or outlet described above. A shape of the element casing is not particularly limited as long as storage in the vessel is not inhibited. Examples of a material of the element casing include a metal, a resin, and a fiber-reinforced plastic (FRP), and can be appropriately selected according to a situation where the element casing is used. A resin is preferable because it has high followability to curing shrinkage of the potting material, and polyphenylene sulfide, polytetrafluoroethylene, polyethylene, polypropylene, polyether ether ketone, polyphenylene ether, polyetherimide, polyamideimide, and polysulfone are more preferable because they have both moldability and chemical resistance.

The module of the present invention includes a covered carbon membrane in which at least one covering yarn is helically wound around one or two fluid-separation carbon membranes. As described above, in the conventional technique, when the carbon membranes are close to each other, defects or breakage are likely to occur due to contact between the carbon membranes, and the potting material is likely to be sucked up due to a capillary phenomenon. In the module of the present invention, the covering yarn is helically wound around one or two fluid-separation carbon membranes used as a core yarn, such that a distance between the covered carbon membranes in the module is increased, and thus, suction of the potting material, defects on the surface of the carbon membrane, or breakage of the carbon membrane can be suppressed. In the module of the present invention, since a three-dimensional position of each of the fluid-separation carbon membranes is gently fixed by the covering yarn, even in a case where breakage occurs in a specific fluid-separation carbon membrane in a module production step, it is possible to suppress defects or breakage on a surface of the surrounding fluid-separation carbon membrane due to a sharp broken surface or broken piece. Further, in the present invention, it is important that one or two fluid-separation carbon membranes are used as the core yarn. In a case where three or more fluid-separation carbon membranes are used as the core yarn, a narrow space surrounded by outer surfaces of the three fluid-separation carbon membranes is formed. Therefore, the potting material is easily sucked up. Further, since each of the fluid-separation carbon membranes receives a force from a plurality of directions by the adjacent fluid-separation carbon membrane in the same covered carbon membrane, defects on the surface of the carbon membrane or breakage of the carbon membrane is likely to occur due to a stress concentration.

In a case where the covered carbon membrane includes one fluid-separation carbon membrane as a core yarn, the covering yarn exists between each of the fluid-separation carbon membranes. Therefore, an appropriate distance between the fluid-separation carbon membranes can be secured. That is, since diffusion of the fluid is not inhibited in a dense portion of the fluid-separation carbon membranes, the fluid in the module can be uniformly diffused, and membrane separation can be achieved by effectively utilizing all the membrane surfaces of the fluid-separation carbon membranes. In addition, the suction of the potting material can be further suppressed. On the other hand, in a case where the covered carbon membrane includes two fluid-separation carbon membranes as a core yarn, the fluid-separation carbon membranes have a substantially double cross-sectional area, such that physical performance such as a tensile load can be improved while maintaining the carbon membrane area, and breakage of the carbon membrane can be further suppressed. A covered carbon membrane including one fluid-separation carbon membrane as a core yarn and a covered carbon membrane including two fluid-separation carbon membranes as a core yarn may be combined.

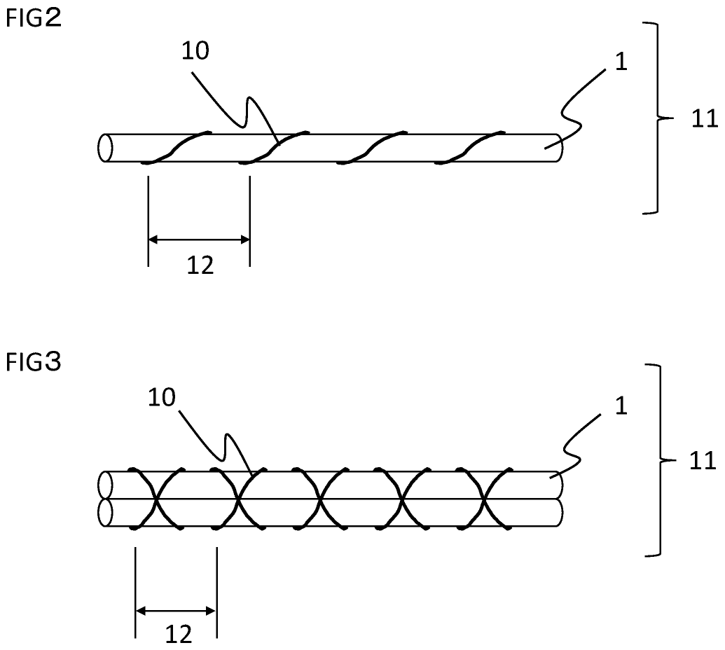

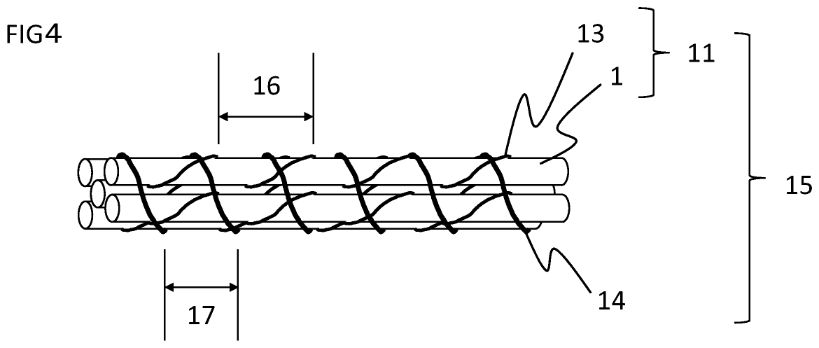

FIGS. 2 and 3 show schematic views of the covered carbon membrane according to one aspect. FIG. 2 is a schematic view of a covered carbon membrane 11 in which one covering yarn 10 is helically covered on one fluid-separation carbon membrane 1 at an interval of a covering pitch 12. FIG. 3 is a schematic view of a covered carbon membrane 11 in which two covering yarns 10 are helically covered on two fluid-separation carbon membranes 1 each at an interval of a covering pitch 12.

The covering by the covering yarn may be single covering in which a covering yarn as a sheath yarn is singly wound around the fluid-separation carbon membrane used as a core yarn, or may be double covering in which a covering yarn is doubly wound around the fluid-separation carbon membrane used as a core yarn.

In the case of the single covering, a covering direction of the covering yarn with respect to the core yarn may be an S direction (right direction) or a Z direction (left direction). In a case where a membrane filling ratio is high, since a volume occupied by the covering yarn can be reduced when the covering yarns of the adjacent covered carbon membranes are aligned, it is preferable that the covering directions of the covering yarns coincide between the covered carbon membranes. On the other hand, in a case where the membrane filling ratio is low, in order to effectively utilize the space between the fluid-separation carbon membranes, it is preferable that the S direction and the Z direction be substantially alternately arranged so that the covering yarns between the adjacent covered carbon membranes intersect with each other.

In the case of the double covering, the covering yarns may be wound around the same core yarn in the S direction and the Z direction, may be wound around the same core yarn in the Z direction and the S direction, or may be doubly wound around the same core yarn in the S direction or the Z direction. When the covering yarns are wound around the same core yarn in the S direction and the Z direction, two covering yarns with respect to the same core yarn intersect with each other at each covering pitch to become bulky, such that the distance between the fluid-separation carbon membranes is further increased, and the suction of the potting material, defect occurrence on the surface of the carbon membrane, and breakage of the carbon membrane are easily suppressed, which is preferable. On the other hand, when the covering yarns are doubly wound around the same core yarn in the S direction or the Z direction, two covering yarns with respect to the same core yarn intersect with each other with a certain probability to become bulky, such that the distance between the fluid-separation carbon membranes is increased as compared to a case where the covering pitch is simply shortened, and the suction of the potting material, defect occurrence on the surface of the carbon membrane, and breakage of the carbon membrane are easily suppressed, which is preferable.

In addition, a fluid-separation carbon membrane module in which a plurality of multiple covered carbon membranes in which a covering yarn is further helically wound around the plurality of covered carbon membranes are housed in a vessel is also one of preferred aspects of the present invention. Multiple covering in which a plurality of covered carbon membranes subjected to single covering or double covering are aligned and used as a core yarn and covering yarns are wound around the core yarn is also one of preferred aspects of the present invention. Since each of the covered carbon membranes subjected to multiple covering has an outer diameter larger than that of the fluid-separation carbon membrane before covering, the multiple covered carbon membrane is easily held, and handleability is further improved. In addition, the tensile load is increased, and occurrence of breakage and defects during modularization can be further reduced. In the case of the multiple covering, since the fluid-separation carbon membranes are suppressed to be close to each other by the first covering, the number of covered carbon membranes covered in the second and subsequent stages is not particularly limited. In the multiple covered carbon membrane, the carbon membranes suppressed to be close to each other are easily aligned, such that the suction of the potting material can be suppressed, and this can suppress occurrence of defects on the surface of the carbon membrane or breakage of the carbon membrane due to the intersect of the carbon membranes with each other. As the core yarn to be covered in the second and subsequent stages, a covered carbon membrane using one fluid-separation carbon membrane as a core yarn and a covered carbon membrane using two fluid-separation carbon membranes as a core yarn may be combined, or an uncovered fluid-separation carbon membrane may be included.

FIG. 4 shows a multiple covered carbon membrane according to one aspect. FIG. 4 is a schematic view of a multiple covered carbon membrane 15 in which five covered carbon membranes 11 in which one covering yarn 13 at the first stage is helically covered on one fluid-separation carbon membrane 1 at an interval of a covering pitch 16 are aligned and used as a core yarn, and one covering yarn 14 at the second stage is further helically covered on the core yarn at an interval of a covering pitch 17. As the covering yarn 13 at the first stage and the covering yarn 14 at the second stage, the same yarns may be used or different yarns may be used. In addition, the multiple covered carbon membrane may have multiplicity of three or more stages.

In the double covered carbon membrane or the multiple covered carbon membrane used in the present invention, sliding of the covering yarn generated on the surface of the fluid-separation carbon membrane is suppressed by a frictional force generated at a portion where the covering yarns intersect with each other. Therefore, the covering pitch can be maintained.

As the plurality of covered carbon membranes housed in the fluid-separation carbon membrane module of the present invention, a covered carbon membrane using one fluid-separation carbon membrane as a core yarn, a covered carbon membrane using two fluid-separation carbon membranes as a core yarn, and a multiple covered carbon membrane may be combined, or an uncovered fluid-separation carbon membrane may be included.

The fluid-separation carbon membrane constituting the covered carbon membrane is not particularly limited as long as it exhibits separation performance according to an application, and can be appropriately selected from any fluid-separation carbon membrane.

The shape of the fluid-separation carbon membrane is not particularly limited as long as it can be covered with a covering yarn, and examples thereof include shapes such as a hollow yarn or a solid yarn, a modified cross-sectional yarn, and a shredded plat membrane. Among them, a hollow yarn shape is preferable because the carbon membrane area per unit volume can be increased. In a case where the fluid-separation carbon membrane has a hollow yarn shape, a hollow portion functions as a fluid passing portion, and passage resistance of the fluid can be reduced.

In a case where the fluid-separation carbon membrane has a hollow yarn shape, an inner diameter of the hollow yarn is preferably 10 μm or more and 1,000 μm or less. When the inner diameter is 10 μm or more, passability of the fluid can be improved. The inner diameter is more preferably 50 μm or more and still more preferably 75 μm or more. On the other hand, when the inner diameter is 1,000 μm or less, the carbon membrane area per unit volume can be increased. The inner diameter is more preferably 500 μm or less and still more preferably 300 μm or less. An outer diameter of the hollow yarn is not particularly limited, and an area ratio of a cross-sectional area A of the hollow portion to a cross-sectional area B of the fluid-separation carbon membrane (A/B: hereinafter, described as a “hollow area ratio”) is preferably 0.01 or more and 0.81 or less. The hollow area ratio is more preferably 0.10 or more because a pressure loss when the fluid flows inside the fluid-separation carbon membrane is reduced to improve the passability of the fluid as the hollow area ratio is increased. On the other hand, since compressive strength in a cross-sectional direction is increased as the hollow area ratio is decreased, the hollow area ratio is more preferably 0.64 or less. Here, the cross-sectional area B of the fluid-separation carbon membrane having a hollow yarn shape is a cross-sectional area including the cross-sectional area A of the hollow portion. In addition, a plurality of hollow portions may be provided from the viewpoint of achieving both pressure resistance and passability, and in this case, the total cross-sectional area of the hollow portions is defined as the cross-sectional area A of the hollow portions.

In a case where the fluid-separation carbon membrane has a hollow yarn shape, as a preferred aspect, a dense layer having separation performance is formed on an inner surface or an outer surface of the hollow yarn membrane having fluid passability. A thickness of the dense layer is not particularly limited, and is preferably 50 μm or less, more preferably 10 μm or less, and still more preferably 5 μm or less, because material permeation resistance is decreased as the dense layer is thin. On the other hand, the thickness of the dense layer is preferably 0.01 μm or more, and more preferably 0.1 μm or more, because the dense layer is strengthened against damage due to an external force when the dense layer is thick.

In addition, as a preferred aspect of the fluid-separation carbon membrane, a fluid-separation carbon membrane including a dense layer and a porous portion having a co-continuous porous structure is also used. In this case, the porous portion functions as a fluid passing portion. Here, the co-continuous porous structure is a structure in which branch parts and pore parts (void parts) of a carbon skeleton are three-dimensionally and regularly intertwined while being continuous. In the case where the porous portion has the co-continuous porous structure, the branch parts support the entire structure, such that the compressive strength of the fluid-separation carbon membrane in the cross-sectional direction is improved.

A proportion of the fluid-separation carbon membranes in the fluid-separation carbon membrane module can be represented by a membrane filling ratio. The membrane filling ratio is calculated as an area ratio (D/C) of a cross-sectional area D based on the outer diameters of all the fluid-separation carbon membranes present at the potting sites to a cross-sectional area C occupied by the potting material in a cross section of the potting site. Here, the cross section of the potting site refers to a cross section perpendicular to the length direction of the fluid-separation carbon membrane at the potting site. Since the carbon membrane area per unit area of the fluid-separation carbon membrane module is increased as the membrane filling ratio is increased, the membrane filling ratio is preferably 0.05 or more, more preferably 0.1 or more, and still more preferably 0.3 or more. On the other hand, the membrane filling ratio is preferably 0.8 or less, and more preferably 0.6 or less, because the fluid-separation carbon membranes can be separated from each other and the pressure loss of the fluid can be reduced as the membrane filling ratio is decreased. The cross-sectional area C occupied by the potting material is a cross-sectional area including the cross-sectional area D of the fluid-separation carbon membrane.

As described above, in the covered carbon membrane used in the present invention, one or two fluid-separation carbon membranes are used as a core yarn. Therefore, in a case where three or more fluid-separation carbon membranes are covered, the multiple covering described above can be suitably used. When a plurality of covered carbon membranes using one or two fluid-separation carbon membranes as a core yarn is subjected to multiple covering, an appropriate distance can be secured between the fluid-separation carbon membranes and a tensile load of a bundle of the fluid-separation carbon membranes can be improved. Since the covered carbon membrane is covered with the covering yarn, the fluid can be moved between the multiple covered carbon membranes, and the multiple covered carbon membranes including arbitrary number of carbon membranes can be continuously produced and modularized.

Yarns having bulkiness and stretchability (hereinafter, described as an “additional yarn”), for example, a crimped yarn, a textured yarn, a spun yarn, and the like are covered by the covering yarn together with the fluid-separation carbon membrane in a state where the additional yarns and the fluid-separation carbon membrane are aligned, which is also one aspect of the present invention. Even in a case where the membrane filling ratio is low, the bulkiness of the covered carbon membranes can be improved by aligning the yarns having bulkiness and stretchability.

In general, since the fluid-separation carbon membrane has high dimensional stability against an environmental change, relaxation or tension of the covering yarn due to the dimensional change of the fluid-separation carbon membrane hardly occurs. Accordingly, an appropriate distance between the fluid-separation carbon membranes can be secured by appropriately selecting a material of the covering yarn without being affected by production conditions and use environment of the module.

Examples of the covering yarn include a polyester yarn, a nylon yarn, a polyolefin yarn, a fluororesin yarn, a polyacetal yarn, and a thermoplastic elastomer yarn. Two or more of these yarns may be used. The polyester yarn and the nylon yarn are preferable from the viewpoint of easiness of false twist texturing. The polyolefin yarn, the fluororesin yarn, the polyacetal resin yarn, and the thermoplastic elastomer yarn are preferable, from the viewpoint of low affinity with the potting material and suppression of suction of the potting material.

The type of the covering yarn is not particularly limited, and may be a monofilament or a multifilament, and the multifilament is preferable from the viewpoint of softness of the covered carbon membrane. In addition, since shrinkability is imparted in a circumferential direction and handleability is improved when the covered carbon membranes are bundled, the false twist textured yarn is preferably used.

The total fineness of the covering yarn is not particularly limited as long as the distance between the fluid-separation carbon membranes is in a range in which the distance is appropriately increased, but when the covering yarn is thick, an appropriate space is formed between the fluid-separation carbon membranes, and passability of the fluid is improved. Therefore, the total fineness of the covering yarn is preferably 50 dtex or more, more preferably 150 dtex or more, and still more preferably 500 dtex or more. On the other hand, when the covering yarn is thin, the covered carbon membrane is soft.

Therefore, the total fineness of the covering yarn is preferably 10,000 dtex or less and more preferably 1,000 dtex or less.

A pitch of the covering yarn (hereinafter, described as a “covering pitch”) is not particularly limited as long as the distance between the fluid-separation carbon membranes is in a range in which the distance is appropriately increased, but when the covering pitch is widened, a space is formed on the surface of the fluid-separation carbon membrane, and the fluid easily flows in and out of the fluid-separation carbon membrane. Therefore, the covering pitch is preferably 0.1 cm or more and more preferably 0.5 cm or more. On the other hand, when the covering pitch is narrow, the fluid-separation carbon membrane can be reinforced by the covering yarn, and defects can be further suppressed. Therefore, the covering pitch is preferably 10 cm or less, more preferably 5 cm or less, and still more preferably 3 cm or less.

Here, the covering pitch of the covered carbon membrane in the present invention can be measured by the following method. First, both end portions of the carbon membrane element (near the boundary between the potting site and the non-potting site) are cut, and a bundle of the covered carbon membranes is taken out from the carbon membrane element. In a case where suction of the potting material occurs, mutually bonded portions are further removed from the bundle of covered carbon membranes. Subsequently, one covered carbon membrane having a length of 5 times or more greater than the covering pitch is randomly sampled while being careful not to twist the covering yarn, the length of the covered carbon membrane with 5 pitches randomly selected is measured, and a covering pitch is calculated by “measured length of covered carbon membrane/number of pitches of covering yarns (5)”. The covering pitch of the multiple covered carbon membrane can also be similarly measured.

Next, a method for producing a module of the present invention will be described by exemplifying a case where a fluid-separation carbon membrane is first produced and covered to obtain a covered carbon membrane, and then the covered carbon membrane is inserted into an element casing or a vessel and is fixed by a potting material.

An example of a method for producing a fluid-separation carbon membrane includes a method in which a polymer membrane is first produced by a carbonizable resin and then dried, the polymer membrane is subjected to an infusibilization treatment such as an oxidation treatment, if necessary, and the polymer membrane is carbonized in an inert atmosphere.

Examples of the carbonizable resin include polyphenylene oxide, polyvinyl alcohol, polyacrylonitrile, a phenolic resin, a wholly aromatic polyester, an unsaturated polyester resin, an alkyd resin, a melamine resin, a urea resin, a polyimide resin, a diallyl phthalate resin, a lignin resin, and a urethane resin. Two or more of these resins may be used.

An eliminable resin that disappears during the production step may be used together with the carbonizable resin. Examples of the eliminable resin include a polyolefin such as polyethylene, polypropylene, or polystyrene, an acrylic resin, a methacrylic resin, polyacetal, polyvinyl pyrrolidone, aliphatic polyester, aromatic polyester, aliphatic polyamide, and polycarbonate. Two or more of these resins may be used. As a preferred aspect of the present invention, an eliminable resin compatible with a carbonizable resin is selected to cause phase separation in a membrane forming process so as to obtain a co-continuous structure.

Examples of a method for forming a polymer membrane include melt spinning, dry spinning, dry-wet spinning, and wet spinning, and can be appropriately selected according to the type of the carbonizable resin. In addition, an appropriate solvent can be used at the time of forming the membrane.

An example of a method for forming a hollow yarn-like fluid-separation carbon membrane includes a method in which a solution containing a carbonizable resin is extruded from an outer tube of a hollow yarn spinning nozzle having a double tube structure, gas such as air or nitrogen, the same solvent as a spinning raw material solution, a solution in which an eliminable resin is dissolved, a non-solvent, a mixture thereof, and the like are extruded from an inner tube of the spinning nozzle, the solution is passed through a coagulation bath, and then the solvent is removed by drying or the like. Examples of a coagulation liquid include water, alcohol, saturated saline, and a mixed solvent of these liquids with an organic solvent. In a case where the solvent or the solution of the eliminable resin is discharged from the inner tube, the solvent or the solution can be immersed in a water washing bath before the drying step, thereby eluting the solvent and the eliminable resin discharged from the inner tube.

In a case where the polymer membrane contains an eliminable resin, it is preferable that the eliminable resin be removed at an arbitrary timing. Examples of a method for removing the eliminable resin include a method for chemically decomposing the eliminable resin using an acid, an alkali, or an enzyme, reducing a molecular weight, and removing the eliminable resin, a method for dissolving and removing the eliminable resin by a solvent that dissolves the eliminable resin, and a method for decomposing and removing the eliminable resin using radiation such as an electron beam, a gamma ray, an ultraviolet ray, or an infrared ray, or heat.

Examples of a method for infusibilizing the polymer membrane include a method in which the polymer membrane is heated in the presence of oxygen to form a crosslinked structure by oxidation, a method in which the polymer membrane is irradiated with a high energy ray such as an electron beam or a gamma ray to form a crosslinked structure, and a method in which the polymer membrane is impregnated or mixed with a substance having a reactive group to form a crosslinked structure. Two or more of these methods may be used in combination. Among them, the method in which the polymer membrane is heated in the presence of oxygen to form a crosslinked structure by oxidation is preferable from the viewpoint of a simple process and low production costs.

As a method for carbonizing the polymer membrane, a method for heating the polymer membrane in an inert gas atmosphere is preferable, and it is more preferable to heat the polymer membrane while continuously supplying the polymer membrane into a heating device maintained at a constant temperature using a roller, a conveyor, or the like. Here, the inert gas refers to gas that is chemically inert during heating, and examples thereof include helium, neon, nitrogen, argon, krypton, xenon, and carbon dioxide. Among them, nitrogen and argon are preferable. The heating temperature is preferably 500° C. or higher and 1,000° C. or lower.

An example of a method for producing a fluid-separation carbon membrane having a dense layer and a porous part having a co-continuous porous structure includes the method described in International Publication No. WO 2016/13676.

One or two obtained fluid-separation carbon membranes are used as a core yarn, and a covering yarn is helically covered to form covered carbon membranes. Examples of a covering device include a covering twisting machine and a double covering twisting machine.

A plurality of obtained covered carbon membranes are bundled and inserted into an element casing or a vessel, and then one end or both ends of the covered carbon membrane are potted by a potting material. Examples of the potting method include a centrifugal potting method in which a centrifugal force is used to permeate between the fluid-separation carbon membranes, and a static potting method in which a potting material in a fluid state is fed by a metering pump or a head to permeate into the fluid-separation carbon membranes.

It is preferable that the potted covered carbon membranes be cut at the potting site to open the fluid-separation carbon membranes. It is preferable that a cap as a pipe joint member be attached to a cut surface of the fluid-separation carbon membrane module so as to be connectable to an external channel (a channel for collecting a fluid permeated into the carbon membrane or the like).

### EXAMPLES

Hereinafter, the present invention will be described in detail with reference to Examples and Comparative Examples, but the present invention is not limited thereto. The evaluation in each of Examples and Comparative Examples was performed by the following method.

(Covering Pitch of Covered Carbon Membrane)

Both end portions of a carbon membrane element (near a boundary between a potting site and a non-potting site) are cut, and a bundle of covered carbon membranes is taken out from the carbon membrane element. In a case where suction of the potting material occurs, mutually bonded portions are further removed from the bundle of covered carbon membranes. Subsequently, one covered carbon membrane having a length of 5 times or more greater than a covering pitch was randomly sampled while being careful not to twist the covering yarn, the length of the covered carbon membrane with 5 pitches randomly selected was measured, and a value calculated by “length of covered carbon membrane/5” was defined as a covering pitch. The covering pitch is schematically shown in FIG. 2. A covering pitch of a multiple covered carbon membrane is similarly measured. The measurement was performed 10 times, and an average value was rounded off to the first decimal place to obtain the covering pitch.

(Handleability)

A time required for housing the covered carbon membranes corresponding to 100 fluid-separation carbon membranes in an acrylic pipe (inner diameter: 5 mm) was measured. In addition, a time required for housing 100 fluid-separation carbon membranes in the acrylic pipe (inner diameter: 5 mm) was also measured. When any one of the covered carbon membranes or the fluid-separation carbon membranes was broken, it was determined that the handleability was “poor”. In a case where breakage did not occur, the handleability was determined as “excellent” when the time required for housing the covered carbon membranes was 50% or less of the time required for housing the fluid-separation carbon membranes, the handleability was determined as “good” when the time required for housing the covered carbon membranes was more than 50% and 80% or less of the time required for housing the fluid-separation carbon membranes, and the handleability was determined as “poor” when the time required for housing the covered carbon membranes was more than 80% of the time required for housing the fluid-separation carbon membranes.

(Suction of Potting Material)

Covered carbon membranes corresponding to 100 fluid-separation carbon membranes were suspended in a bundle, and a potting material (epoxy resin) was injected so that 1 cm from a lower end of the bundle was immersed. The potting material left to stand in a thermostatic chamber at a temperature of 50° C. for 12 hours was cured, the bundle was unwound from an upper end, and then, a portion where the bundle was not unwound (a portion where all the carbon membranes were adhered by sucking up the potting material) was defined as an arrival point of the potting material. A distance between the cured surface and the arrival point of the potting material was measured and used as a suction height of the potting material. In Comparative Example 1, 100 fluid-separation carbon membranes were suspended in a bundle and evaluated in the same manner, and the distance between the cured surface of the potting material and the arrival point was similarly measured.

(Breakage of Carbon Membrane)

The prepared module was visually observed, and when breakage of the carbon membrane was observed through the acrylic pipe that was a vessel, it was determined that the breakage was “large”. When breakage was not visually observed, the entire module or all of the inlets and outlets were immersed in water for 1 minute in a state where pressurized air having a gauge pressure of 0.2 MPa was injected from a carbon membrane opening of the potting site. It was determined as “presence” when bubbles were generated from either the inlet or the outlet in water, and it was determined as “absence” when the generation of air bubbles was not observed.

(Defects of Unit Carbon Membrane)

The covered carbon membranes corresponding to 100 fluid-separation carbon membranes were bundled and put in and taken out from an acrylic pipe (inner diameter: 5 mm) 10 times. Thereafter, the covering yarns of the covered carbon membranes were carefully removed, and one randomly selected fluid-separation carbon membrane having a length of 10 cm was collected. One end was sealed with an epoxy resin, the other end was connected to a tube so as not to seal the carbon membrane, and the entire fluid-separation carbon membranes were immersed in water in a state where pressurized air having a gauge pressure of 0.2 MPa was injected from the other end. After immersion for 1 minute, the number of bubbles attached to the surface of the fluid-separation carbon membrane in water was visually counted and divided by the length of the fluid-separation carbon membrane in water to calculate the number of defects per unit length. In Comparative Example 1, 100 fluid-separation carbon membranes were bundled and put in and taken out from an acrylic pipe (inner diameter: 5 mm) 10 times, and one randomly collected fluid-separation carbon membrane was similarly evaluated. The measurement was performed 10 times, and an average value was taken as the number of defects of the unit carbon membrane.

### Production Example 1

### Preparation of Fluid-Separation Carbon Membrane)

10 parts by weight of polyacrylonitrile (PAN) (MW: 150,000) manufactured by Polysciences, Inc., 10 parts by weight of polyvinyl pyrrolidone (PVP) (MW: 40,000) manufactured by Sigma-Aldrich Co. LLC, and 80 parts by weight of dimethyl sulfoxide (DMSO) manufactured by FUJIFILM Wako Pure Chemical Corporation were mixed, and the mixture was stirred at 100° C. to prepare a spinning raw material solution.

The obtained spinning raw material solution was cooled to 25° C., an 80 wt % aqueous solution of DMSO was discharged from the inner tube, the spinning raw material solution was discharged from a middle tube, and a 90 wt % aqueous solution of DMSO was discharged from the outer tube at the same time using a concentric triple spinneret, and then, the solutions were guided to a coagulation bath containing pure water at 25° C. and wound around a roller, thereby obtaining a yarn. The obtained yarn was washed with water and then dried at 25° C. for 24 hours using a circulation dryer to prepare a precursor of a hollow yarn-like porous carbon membrane.

The obtained precursor of the porous carbon membrane was passed through an electric furnace at 250° C., and the precursor was heated in an air atmosphere for 1 hour, and the heated precursor was subjected to an infusibilization treatment, thereby obtaining an infusibilized yarn. Subsequently, the infusibilized yarn was carbonized at a carbonization temperature of 650° C. to obtain a fluid-separation carbon membrane having an outer diameter of 300 μm and an inner diameter of 100 μm (a hollow area ratio was 0.11).

### Example 1

A covered carbon membrane was produced by winding a 170 dtex polyester false twist textured yarn around one fluid-separation carbon membrane obtained by Production Example 1 used as a core yarn at a pitch of 1 cm in a Z direction.

100 covered carbon membranes obtained were bundled and housed in an acrylic pipe (inner diameter: 5 mm) having an inlet, and both ends of the acrylic pipe were each subjected to static potting using an epoxy resin. After curing the epoxy resin, the potting site at one end was cut with a rotary saw to open the fluid-separation carbon membranes, thereby obtaining a module in which a membrane filling ratio of the fluid-separation carbon membranes was 0.36. As a result of evaluation performed by the method described above, the handleability was “good”, the breakage was “absence”, the number of defects per unit length was 0.2 number/cm, and the suction height of the potting material was 0.8 cm.

### Example 2

A module was produced in the same manner as that of Example 1 except that the covering pitch of the covered carbon membrane was changed to 5 cm. As a result of evaluation performed by the method described above, the handleability was “good”, the breakage was “absence”, the number of defects per unit length was 0.6 number/cm, and the suction height of the potting material was 0.8 cm.

### Example 3

A covered carbon membrane was produced by winding a 170 dtex polyester false twist textured yarn around two fluid-separation carbon membranes obtained by Production Example 1 used as a core yarn at a pitch of 1 cm in a Z direction. 50 covered carbon membranes obtained were bundled, and a module was produced in the same manner as that of Example 1. As a result of evaluation performed by the method described above, the handleability was “excellent”, the breakage was “absence”, the number of defects per unit length was 0.5 number/cm, and the suction height of the potting material was 1.0 cm.

### Example 4

A multiple covered carbon membrane was produced by winding a 170 dtex polyester false twist textured yarn around five fluid-separation carbon membranes obtained in Example 1 used as a core yarn at a pitch of 1 cm in a Z direction.

20 multiple covered carbon membranes obtained (100 fluid-separation carbon membranes) were bundled and housed in an acrylic pipe (inner diameter: 5 mm) having an inlet, and both ends of the acrylic pipe were each subjected to static potting using an epoxy resin. After curing the epoxy resin, the potting site at one end was cut with a rotary saw to open the fluid-separation carbon membranes, thereby obtaining a module. As a result of evaluation performed by the method described above, the handleability was “excellent”, the breakage was “absence”, the number of defects per unit length was 0.1 number/cm or less, and the suction height of the potting material was 0.5 cm.

### Comparative Example 1

A module was produced in the same manner as that of Example 1, except that 100 fluid-separation carbon membranes obtained by Production Example 1 were bundled and used as they were instead of the covered carbon membranes. As a result of evaluation performed by the method described above, the handleability was “poor”, the breakage was “large”, the number of defects per unit length was 2.1 number/cm, and the suction height of the potting material was 4.8 cm.

### Comparative Example 2

A covered carbon membrane was produced by winding a 170 dtex polyester false twist textured yarn around five fluid-separation carbon membranes obtained by Production Example 1 used as a core yarn at a pitch of 1 cm in a Z direction. 20 covered carbon membranes obtained were bundled, and a module was produced in the same manner as that of Example 1. As a result of evaluation performed by the method described above, the handleability was “excellent”, the breakage was “large”, the number of defects per unit length was 1.7 number/cm, and the suction height of the potting material was 3.3 cm.

### INDUSTRIAL APPLICABILITY

The fluid-separation carbon membrane module of the present invention can be suitably used for a system for separating and storing carbon dioxide from exhaust gas of a power plant, a blast furnace, and the like, sulfur component removal from gasified fuel gas in coal gasification combined power generation, purification of biogas or natural gas, purification of hydrogen from organic hydrides, and the like.

### DESCRIPTION OF REFERENCE SIGNS

1: Fluid-separation carbon membrane

2: Potting site

3: Adapter

4: Vessel

5: Inlet

6: Outlet

7: Element casing

8: Carbon membrane element

9: Cap

10: Covering yarn

11: Covered carbon membrane

12: Covering pitch

13: Covering yarn at first stage

14: Covering yarn at second stage

15: Multiple covered carbon membrane

16: Covering pitch of covering yarn at first stage

17: Covering pitch of covering yarn at second stage

1. A fluid-separation carbon membrane module, wherein a plurality of covered carbon membranes in which at least one covering yarn is helically wound around one or two fluid-separation carbon membranes are housed in a vessel.

2. The fluid-separation carbon membrane module according to claim 1, wherein the covered carbon membrane is obtained by winding a covering yarn around one fluid-separation carbon membrane.

3. The fluid-separation carbon membrane module according to claim 1, wherein the covered carbon membrane is obtained by winding a covering yarn around two fluid-separation carbon membranes.

4. The fluid-separation carbon membrane module according to claim 1, wherein a covering pitch of the covering yarn is 0.1 cm or more and 10 cm or less.

5. The fluid-separation carbon membrane module according to claim 1, wherein the covering yarn includes at least one yarn selected from the group consisting of a polyester yarn, a nylon yarn, a polyolefin yarn, a fluororesin yarn, a polyacetal yarn, and a thermoplastic elastomer yarn.

6. The fluid-separation carbon membrane module according to claim 1, wherein the covering yarn is a false twist textured yarn.

7. The fluid-separation carbon membrane module according to claim 1, wherein the plurality of covered carbon membranes are housed in the vessel as a multiple covered carbon membrane in which at least one covering yarn is further helically wound around the plurality of covered carbon membranes.
